(19) United States
(12) Patent Application Publication
(10) Pub. No.: US 2007/0275209 A1
(43) Pub. Date: Nov. 29, 2007

(54) Non-Skid Drop Cloth

(75) Inventors: Anil Netravali, Ithaca, NY (US); Om P. Gupta, Ithaca, NY (US)

Correspondence Address: BROWN & MICHAELS, PC;400 M & T BANK BUILDING, 118 NORTH TIOGA ST, ITHACA, NY, 14850, US

(73) Assignee: DIGICOMP RESEARCH CORPORATION, Ithaca, NY (US)

(21) Appl. No.: 11/420,545

(22) Filed: May 26, 2006

(51) Int. Cl. B32B 3/06

(52) U.S. Cl. 428/99; 428/174

(57) ABSTRACT

A skid-resistant plastic sheets that can reduce or overcome the problem of slippage and hence reduce the bodily injuries as well as equipment damage. Various ways to achieve or obtain skid-resistance in single plastic sheets are described. These skid-resistant dust protective plastic sheets may be manufactured in one step process or two-step process and fall into two categories; 1) those that embody topographical changes and 2) those that have a discontinuous coating of a skid-resistant material on one or both sides and are discussed separately.

### BACKGROUND OF THE INVENTION

1. Field of the Invention

The invention pertains to the field of plastic sheeting. More particularly, the invention pertains to plastic sheets or films commonly used to cover and protect the furniture, floors, walls, etc., during construction, painting, etc., and ways to make them slip-resistant.

2. Description of Related Art

Dust protective plastic sheets or films or sheeting are commonly used to cover the furniture, walls, flooring and other exposed items during painting, construction, building maintenance, remodeling, decoration, cleaning or other operations in houses or commercial buildings (henceforth called project). Besides protecting the furniture, floors, walls, etc., from the dust, spilled liquids and debris created during painting, construction, maintenance, etc., these plastic sheets also make it easier and faster to clean the site after the project has been completed. The dust and debris collected on the sheet are conveniently disposed of along with the sheets.

Most plastic sheets used for such purposes comprise of single ply films and are impermeable and do not allow any liquids (e.g. paint) to leak through. The production (manufacturing) of these sheets commonly involves extruding through slits and stretching to obtain better mechanical properties and dimensions (thickness and width). They may also be made other ways including blowing.

Regardless of the way these sheets are manufactured, they tend to have a smooth surface. Although they protect the furniture and other covered items from dust, debris and spilled liquids during the job, their smoothness presents a distinct disadvantage. They tend to be very slippery when placed over smooth surfaces such as laminate flooring, wooden flooring, tiled flooring and other smooth floorings and furniture tops on which they are commonly placed. The sheets containing fine dust created during the construction could also enhance the skidding and slippery nature of these sheets, particularly when placed on smooth surfaces.

This slippery nature of the plastic sheets could be dangerous for people walking on the sheets who could skid and fall down on the furniture, floor or tools being operated, such as cutting saw or drill, during the project endangering their lives and physical well being. Often the ladders kept on these plastic sheets might slip injuring the person standing on the ladder. The fall of ladders and other equipment in such accidents may also cause considerable damage to the third party property. The slipperiness and the resultant danger is more pronounced if such smooth plastic sheets are placed over one another (double layer) or one sheet is folded over itself.

Although there have been a few patents in the recent past related to protective and absorbent covers, these sheets are most commonly made of polyethylene and have a smooth surface. A brief summary of the recent patents is presented in the next paragraph.

A 1999 UK Patent Application GB2381236 shows a ‘Protective sheet’ consisting of two plies of blended polyethylene including anti-slip agent. The first ply consisted of a non-slip backing and a second ply consisted of non-slip air pockets with the first ply. Another published UK application is for ‘A decorator's non-slip absorbent dust sheet’ GB2402875 (2004). The absorbent sheet in this case consisted of an absorbent fabric layer with a waterproof backing serving as non-slip surface.

US published patent application 2001/0055927 for a ‘Highly drapable protective cover having ultrathin non-woven absorbent layer’ includes a cover having two layers put together (or bonded). The first layer includes a nonwoven fabric material and the second layer is a plastic material. The main application of this invention is protective drop cloth for furniture.

Two US patents, U.S. Pat. Nos. 4,045,270 and 4,488,918 have been issued for making Non-slip Plastic Films, in 1977 and 1984, respectively. The first patent (U.S. Pat. No. 4,045,270) comprises extruding separate plasticized plastic materials in two separate streams so that one stream abuts against and adheres to the other to form a joint plastic layer. The combined plastic layer is then stretched by directing air centrally into a tubular formation. One of these two plastic layers has an expanding agent or a foaming agent. The stretching causes the breaking of voids of the foam plastic forming a rough, irregular net-like formation on the exterior of the other plastic. This roughness acts as skid-free (non-slip) surface. This patent also describes the air blowing process and apparatus. The skid-free surface is only on one side. Also, this patent must have two separate films that need to be extruded simultaneously.

The other patent (U.S. Pat. No. 4,488,918) is similar to the one described above and discloses a plastic film having a non-slip surface comprising spaced random patterns of rigid peaks and ridges formed by a second thermo-plastic layer coextruded with and bonded to the film and rupturing the second layer during expansion. As in the case of U.S. Pat. No. 4,045,270, this also needs two plastic layers, one of which forms a hard rough texture on the surface of the other. This rough surface, containing sharp ridges and peaks, resembles a sandpaper and acts as non-slip surface.

### SUMMARY OF THE INVENTION

The present invention comprises skid-resistant (may also be called slip-resistant, non-slip, non-skid, anti-slip, anti-skid, skid-proof, slip-proof, skid-free, slip-free, etc.) plastic (or polymer) sheets that can reduce or overcome the problem of slippage and hence reduce the bodily injuries as well as equipment damage. Various ways to achieve or obtain skid-resistance in single plastic sheets are described. These skid-resistant dust protective plastic sheets may be manufactured in one step process or two-step process and fall into two categories; 1) those that embody topographical changes and 2) those that have a discontinuous coating of a skid-resistant material on one or both sides and are discussed separately.

### BRIEF DESCRIPTION OF THE DRAWING

FIGS. 1a and 1b show cross sectional views of an embodiment of the invention having semi-spherical suction cups.

FIG. 2 shows an isometric view of the embodiment of FIG. 1a.

FIGS. 3a through 3g show cross sectional views of embodiments of the invention with different shapes and heights of suction cups.

FIG. 4 shows a method of forming suction cups on one side of the extruded plastic sheet of the invention.

FIG. 5 shows a method for forming suction cups on one side using pre-extruded plastic sheet.

FIG. 6a shows a top view of a plastic tape with semi-spherical suction cups on one side.

FIGS. 6b through 6d show cross sectional views of tape with different sizes of suction cups.

FIG. 7a shows a top view of an embodiment of the invention using tapes with suction cups.

FIG. 7b shows a cross sectional view of the embodiment of FIG. 7a.

FIG. 8 shows a cross sectional view of the embodiment of FIG. 7a, having tapes with suction cups attached on both sides.

FIGS. 9a and 9b show cross sectional views of an embodiment of the invention with suction cups without tapes attached to one side and both sides, respectively.

FIGS. 10a through 10f show different patterns for an embodiment of the invention having a skid-resistant discontinuous coating on the plastic sheet.

FIGS. 11a and 11b show cross section views of the embodiment of FIGS. 10a-10f having coatings on one side and both sides, respectively.

FIGS. 12a and 12b show cross section views of the embodiment of FIGS. 11a and 11b, in which the coating contains particles.

FIG. 13 shows a method of creating the coatings of FIGS. 10-12.

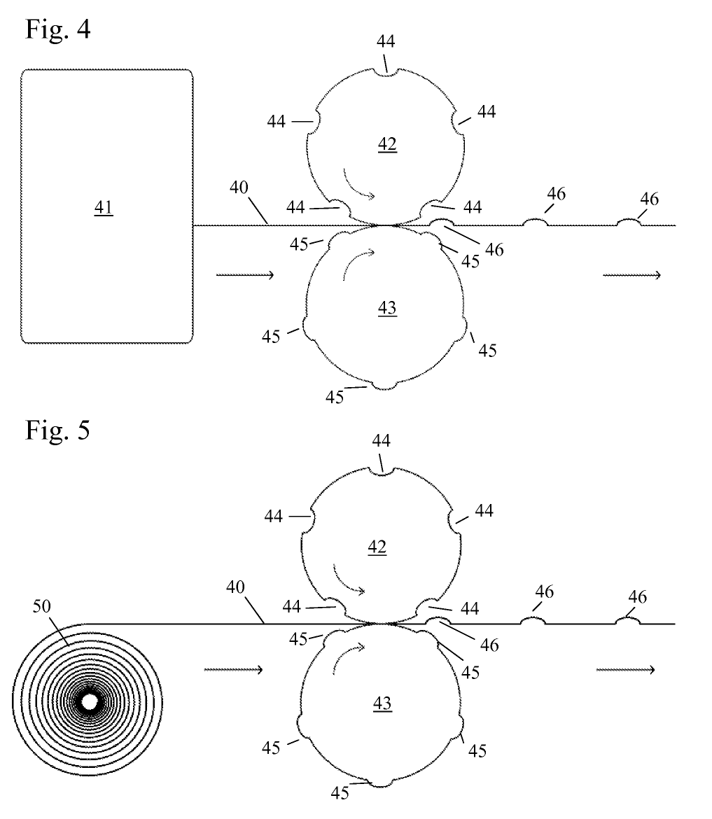

n alternative to the method of FIG. 4, using molds instead of rollers.

### DETAILED DESCRIPTION OF THE INVENTION

The present invention comprises skid-resistant (may also be called slip-resistant, non-slip, non-skid, anti-slip, anti-skid, skid-proof, slip-proof, skid-free, slip-free, etc.) plastic (or polymer) sheets that can reduce or overcome the problem of slippage and hence reduce the bodily injuries as well as equipment damage. Various ways to achieve or obtain skid-resistance in single plastic sheets are described.

### Sheets with Suction Cup Embodiments

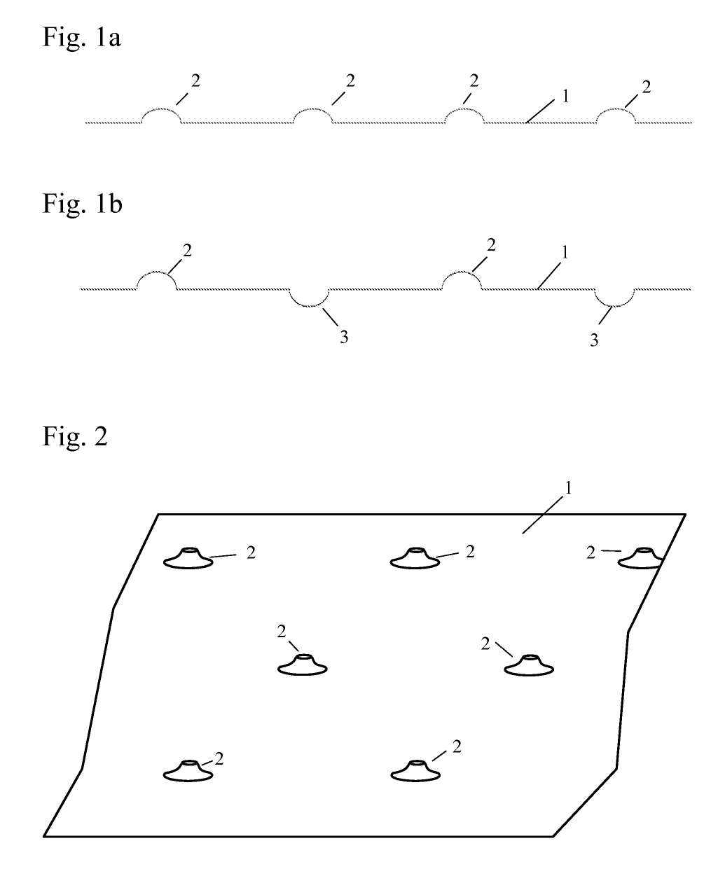

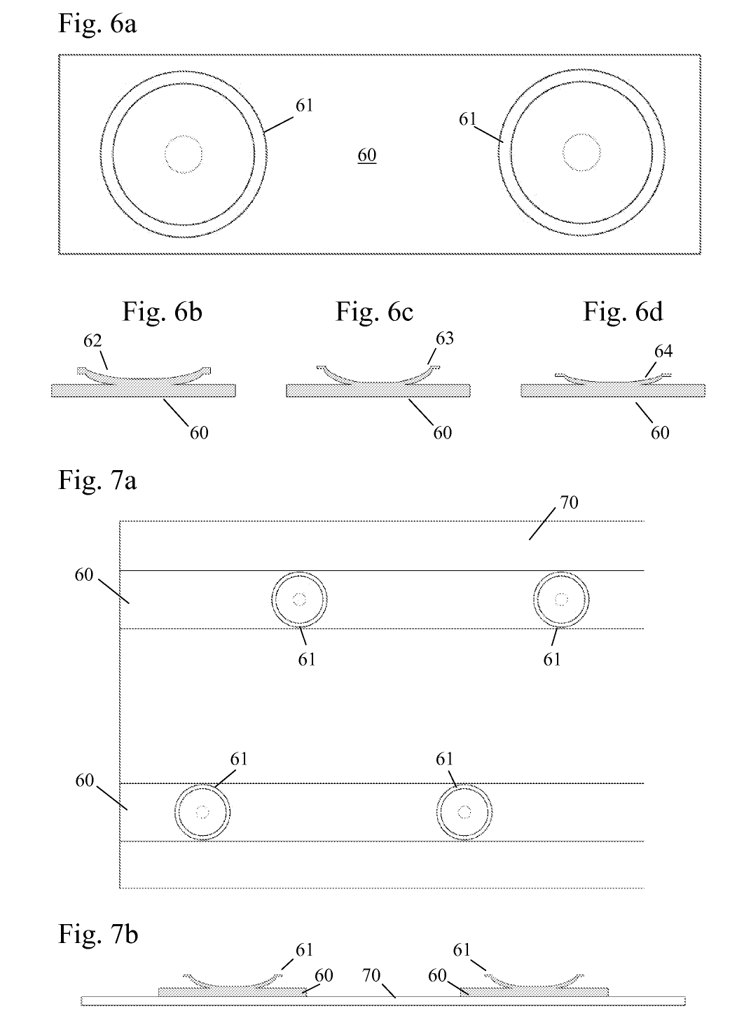

The first embodiments of the invention, as shown in FIGS. 1-9, are plastic sheets with suction cups. FIGS. 1-5 show embodiments in which the suction cups are designed as part of the base sheet. FIGS. 6-9 show embodiments in which the suction cups are formed on thin tapes which are applied to the base sheet.

Referring to FIGS. 1-3, the invention comprises a base plastic sheet (1). The sheet (1) may be of various plastics (polymers) including all varieties of polyethylene (PE) such as linear low density polyethylene (LLDPE), low density polyethylene (LDPE), medium density polyethylene (MDPE), and high density polyethylene (HDPE), polypropylene (PP), plasticized poly(vinyl chloride) (PVC), most varieties of nylons, most varieties of polyesters, and any other flexible thermoplastic polymers/plastics that can be extruded into sheets. The thickness of these sheets can be varied depending on the application; thin sheets for light duty and thicker sheets for heavier duty.

Suction cups (2) are formed as part of the sheet (1). Upon initial force (pressure), such as a person stepping on it or the legs of a furniture piece or ladder being placed on it, or any vehicular traffic, etc., the suction cups (2) are deformed and the air inside the cups is forced out. This action creates vacuum or low pressure area inside the cups which provides a suction force that acts to adhere (or stick) the sheet to the surface it is against (floor, wall, flat furniture surface, etc.) and prohibits (or resists) it from slipping. The suction (or vacuum) action created will increase with increased force, e.g., heavier person stepping on it, or with plurality of suction cups, or with larger size suction cups.

The suction cup (2) design can be imparted on one side or on both sides (preferable) of the sheet depending on the application and need. FIG. 1 (a) and FIG. 1 (b) show the cross sections of the skid-resistant dust protective sheets with semi-spherical suction cups on one side or both sides, respectively. FIG. 2 shows an isometric view of a skid-resistant dust protective sheet with suction cups on one side.

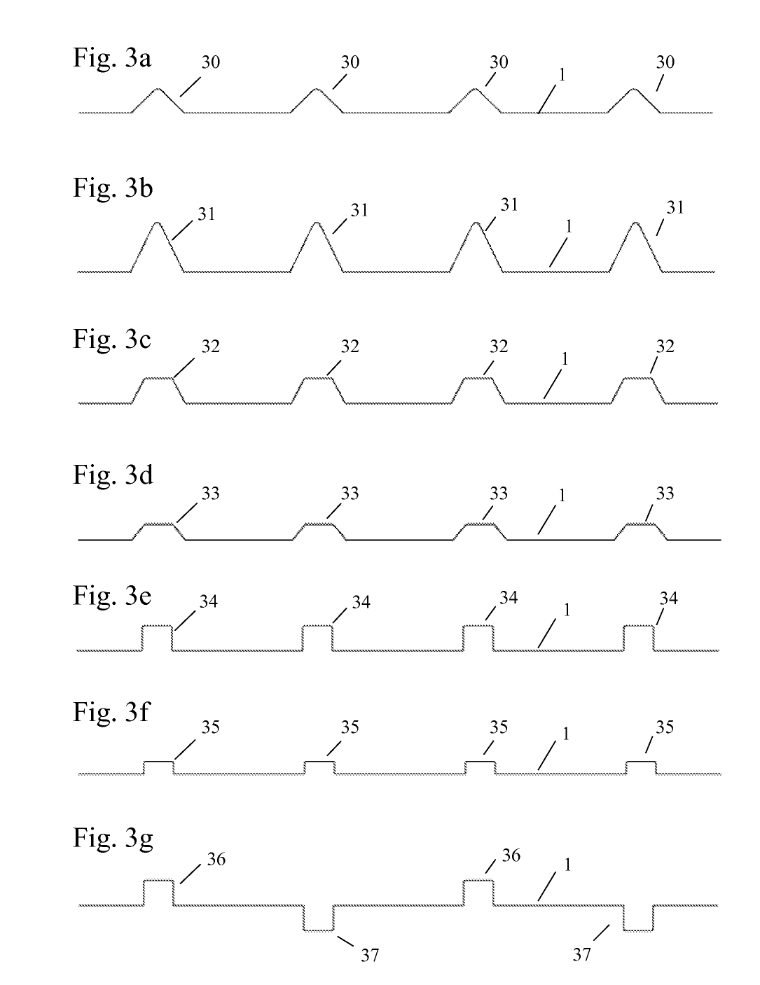

The shapes and heights of the suction cups may be different as shown in FIGS. 3a through 3f. For example, the cups can be conical (FIGS. 3a and 3b) with low (30) or high profiles (31). The cones can be truncated (FIGS. 3c and 3d), again with lower (32) and higher profiles (32). Alternatively, the cups could be cylindrical (FIGS. 3e through 3g) with high (34) or low (35) profiles, and can be both the upper surface (cups (36)) and lower surface (cups (37)). Several other shapes will also work as long as the suction cup action is created and maintained during use.

The spacing of the suction cups, in either direction (longitudinal—along the length of the sheet and widthwise), will depend on their depth (height), shape and size (diameter) as well as the type of the polymer and thickness of the sheet used. For suction cups with higher depth and/or larger sizes, the spacing between them may be increased. Typical spacing could be between 12 mm (½ in) to 50 mm (2 in) apart in both directions (longitudinal and widthwise direction). Typical diameter of the cup may vary between 3 mm (0.12 in) to 6 mm (0.25 in). However, suction cups smaller than 3 mm (0.12 in) or larger than 6 mm (0.25 in) in diameter will work for many applications.

The cups may be spaced randomly in both directions (longitudinal and widthwise) or in any desired pattern. The circular area surrounding the suction cup might be made glossy smooth (flat), for better (or complete) contact with the smooth surfaces it will be in contact with (e.g. laminate flooring, wooden flooring, tiled flooring and other smooth floorings or another plastic sheet) and to retain the suction effect for longer term. In addition to the suction action, the roughness created by the suction cup pattern will also help the skid-resistant dust protective plastic sheet reduce the slippage.

FIGS. 4, 5 and 14 show methods of manufacturing the sheets of FIGS. 1 through 3. In these methods, a pair of embossed/engraved rollers (male (43), having bumps (45) and female (42) having depressions (44)) press the sheet (40) between them, embossing cups (46) into the sheet (40). Alternatively, bumps (45) and matching depressions (44) may be mixed on both rollers (42) and (43) to form cups on both sides of the sheet, as shown in FIGS. 1b and 3g.

The embossing/engraving will be done according to the shape, height and the spacing of the suction cups. The newly extruded plastic/polymer sheet will pass through the nip of these rollers creating the suction cup design.

The rollers may or may not be heated, depending on the necessity. If the newly extruded sheet is hot enough, the rollers may not be needed to be heated. However, heated rollers may make it easier to form the suction cups. The temperature will depend on the type of polymer used and the speed of the operation.

In another version of manufacturing, shown in FIG. 14, the plastic sheet (140) may be passed between a male (142) planar mold having bumps (145) and a female planar mold (142) having depressions (144), which open and close on the sheet (140) to create the suction cup (146) design. Although two different ways are described, there might be other ways of manufacturing such sheets as well. Any other suitable method to achieve the same objectives will also do.

In either of the cases discussed above, the process could be completed in one step when the rollers (42)(43) or molds (142)(143) are operated in line (simultaneously) with the extrusion machine (41), as shown in FIG. 4. However, the same can be achieved in two steps (operations), the second of which is shown in FIG. 5. In this case, the first step will be to extrude the plastic film by any suitable method (not shown) and wind it on to convenient roll (50). The second step will be to pass the sheet (40) from the roll (50) through the nip of the embossed/engraved rollers (42)(43) or in between the male-female molds.

In another embodiment of the sheets with suction cups, as shown in FIGS. 6-9, a thin plastic (polymer) tape (60) with suction cups (61) is produced in the first step. Suction cups (61) with semi-spherical shapes similar to the ones shown in FIG. 1 (a) or different shapes (square, oblong, etc.) may also be produced on the plastic (polymer) tape (60). The material used for the tape will preferably be of the same material as the sheet. This tape (60) with suction cups (61) can be attached to the sheet (70) immediately after being extruded or any time afterwards.

FIGS. 6b through 6d show a cross-section of the tape (60) at one of the suction cups. As shown in these figures, the cups (62)(63) and (64) may be varied in height and diameter.

The attaching (bonding) of the tape (with the suction cups) to the plastic sheet, lengthwise, might be accomplished by the use of adhesive, heat (thermal) bonding, ultrasound or any other possible method that will achieve good bonding.

FIG. 7a shows the plastic sheet (70) with the tapes (60) attached. FIG. 7b shows the cross section of the plastic sheet (70) and tapes (60) at the suction cup (61) locations. Note that the dimensions used in figures are demonstration only and are not representative of the actual dimensions.

Such tapes with suction cups may be easily produced by injection molding or by using simple molds. Currently some bath mats with suction cups at the bottom are commonly produced and used.

If the plastic sheet (70) and the tape (60) (with the suction cups (61)) are made using same or chemically similar materials (e.g. PE, PP, etc.), it is easier to heat (thermal) bond them together; particularly during the extrusion of the sheet. It is also possible to bond two different materials (plastics/polymers), although a little harder, depending on their chemistry. For example, if one of the materials is non-polar such as PE (all varieties), PP (all varieties), PET or other polymers, there may be problems in bonding it to the other material. For such polymers, techniques such as corona discharge and atmospheric pressure plasma (also called open air plasma) can be easily applied to make their surface polar. These techniques incorporate oxygen and nitrogen containing chemical groups thus changing the surface characteristics of the polymers to more polar, improving their chemical bonding capability. The chemical bonding in such cases may be covalent or hydrogen bonding. Using such techniques it is possible to modify the surface of the plastic sheet to specifically suit the chemistry of the skid-resistant material. This allows the skid-resistant plastic and the tape to bond well. Atmospheric pressure plasma and corona treatments can be applied on line, during the extrusion of the sheet and their cost should be minimal.

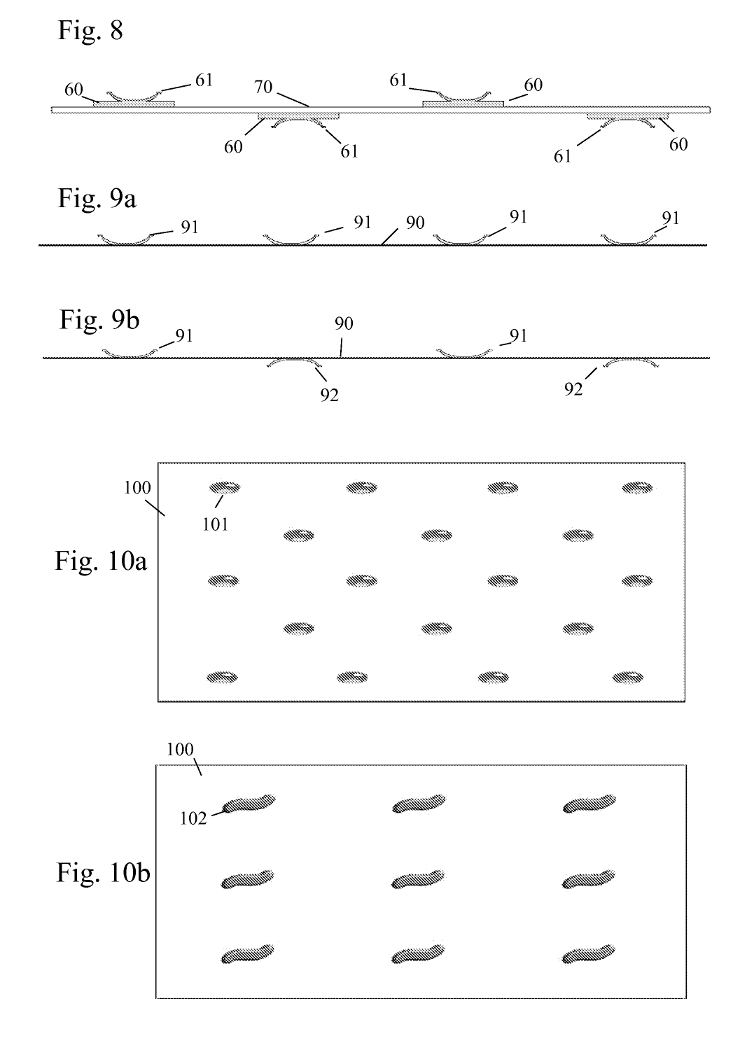

The tape (60) (with the suction cups (61)) may be attached on one side or both sides of the plastic sheet depending on the necessity and the application of the sheet. A cross section of a skid-resistant dust protective sheet (70) with tapes (60) attached to both sides is shown in FIG. 8.

The spacing between the tapes on the plastic sheet and the placing of (distance between) the suction cups on the tape can be varied as desired. The size (diameter) and the depth (height) of the suction cups can also be varied as desired. In general, thinner skid-resistant dust protective sheets may use suction cups with smaller diameters and smaller depth (heights). Thicker skid-resistant dust protective sheets may use more suction cups per unit area or suction cups with larger diameters or larger depth. The circular area surrounding the suction cup outside edge might be made glossy smooth (flat) for better contact with the smooth surfaces it will be in contact with (e.g. laminate flooring, wooden flooring, tiled flooring and other smooth floorings or another plastic sheet) and to retain the suction action effectively over longer periods.

It may also be possible to attach suction cups without the use of the polymer tape. In such cases, the cups may be directly attached or bonded to the sheet on one side or both sides. FIG. 9a shows the cross sections of the sheet (90) with cups (91) attached to one side, and FIG. 9b shows the sheet (90) with cups (91) and (92) attached to both sides, respectively. In this case also, the shapes, sizes, spacing and heights of the cups may be varied to specific applications. The material used for the plastic sheet and cups (tapes) may be same or different as mentioned earlier.

The suction cup design will also allow these skid-resistant dust protective sheets to be installed on vertical surfaces (e.g. walls or furniture). Once a small pressure is applied against these skid-resistant dust protective sheet and the suction cups (vacuum) are activated, the sheets will remain in place until pulled apart when desired. Conventional plastic sheets currently being used do not have such mechanism and readily fall off such vertical surfaces unless taped or somehow attached or held.

### Skid-Resistant Polymer Coating Embodiments

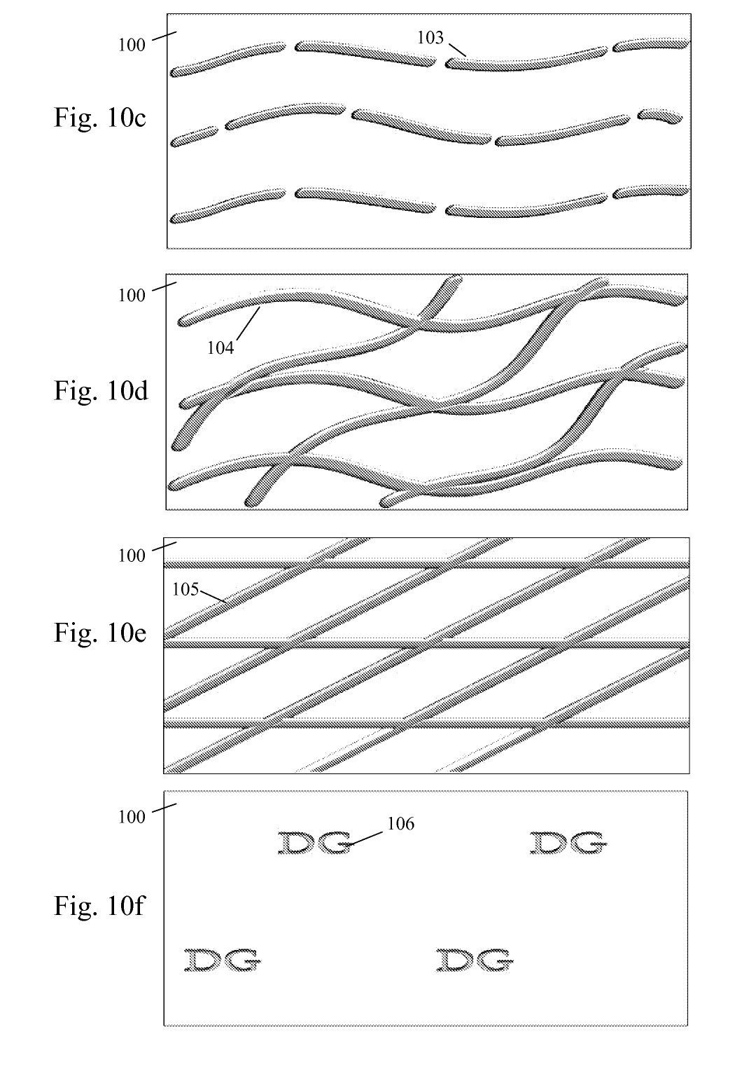

In other embodiments of the skid-resistant dust protective sheets of the invention, as shown in FIGS. 10-13, an elastomer or adhesive-like or non-adhesive tacky material or softer material (101), all with skid-resistant properties may be applied as a discontinuous coating to the base sheet (100). This skid-resistant coating may be applied on one side or both sides depending on the necessity and application, although coating on both sides is preferred for better performance.

The discontinuous skid-resistant coating may take various forms, as shown in FIGS. 10a through 10f. For example, the coating could be a pattern of dots/squares (101), “squiggles” (102), sinusoidal or straight continuous or broken lines (103), or a grid of intersecting lines (104) or (105) running along the length or width of the sheet. The coating could be in the form of a company logo (106), or any other simple repeatable pattern/design. Any designs and patterns with sufficient area covered with the skid-resistant material should work.

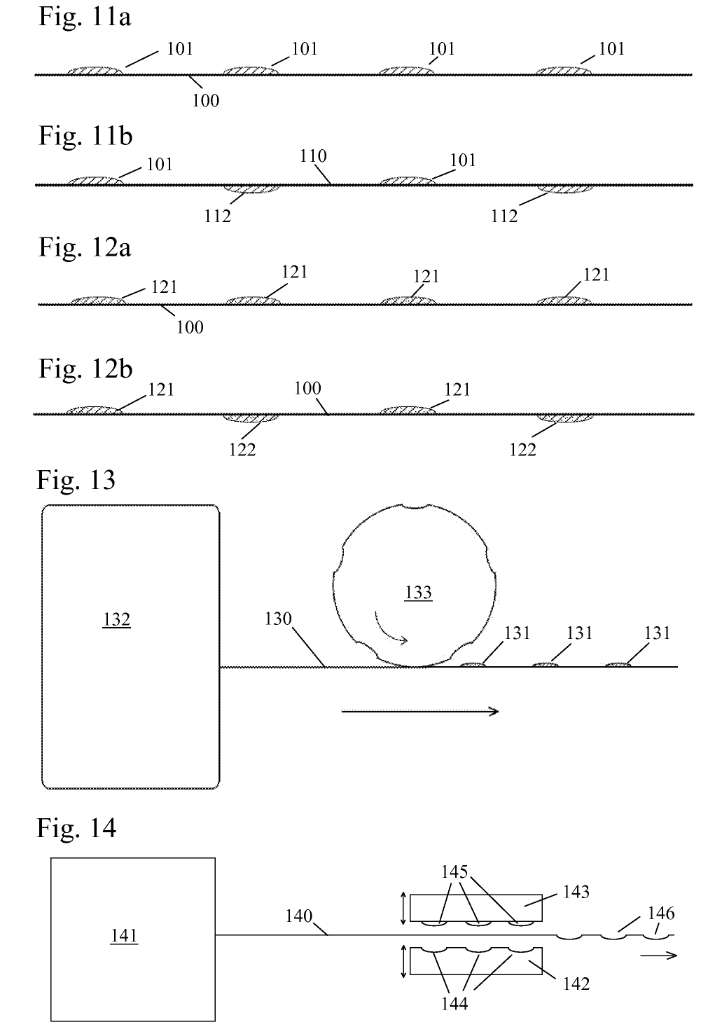

The skid-resistant discontinuous coating, although very thin, will have some thickness of its own and hence will project above the surface of the sheet. FIG. 11a shows a cross sectional view of the skid-resistant dust protective sheet (100) with bead (101) pattern shown in FIG. 10a, for illustration. FIG. 11b shows the cross sectional view of the sheet (100) having the discontinuous bead (101) and (112) pattern on both sides. Please note that the thicknesses of the sheet and the skid-resistant coating in these figures are not shown in proportion.

The presence of the discontinuous coating of the skid-resistant properties, results in a significant increase in the coefficient of friction of the plastic on that side. This additional friction capability imparts the sheet with the skid-resistance characteristics. The discontinuous design of the skid-resistant material will provide a textured surface.

A host of elastomeric skid-resistant materials including but not limited to amorphous olefin polymers, urethanes, copolymers, various ethylene propylene copolymers, propylene 1-butene copolymers, higher propylenes, terpolymer analogs, ethylene vinyl acetate copolymers (hot melt or water based emulsions) styrene-butadiene, (hot melt or water based emulsion) cellulose acetate butyrate (hot melt), ethyl cellulose (containing plasticizers applied as hot melt), a variety of acrylics, natural rubber, variety of high tack rubber based adhesives, variety of synthetic rubber hot melts, and several other hot melts can be used for this purpose. All varieties of the materials mentioned above are commercially available. Since the skid-resistant material does not cover the entire surface of the plastic sheet, the cost can be controlled with the design.

To reduce the cost of the skid-resistant coating materials even further, a variety of fillers or combinations of fillers may be added to them. These include calcium carbonate, a variety of clays and other inexpensive materials that are commercially available in fine particle form. The fillers may be added such that the material properties, especially the coefficient of friction, will not be altered significantly. FIG. 12a shows the embodiment of FIG. 10a, in which the beads (121) contain filler. FIG. 12b shows the cross sectional view of the sheet having the discontinuous bead pattern (121) and (122) on both sides.

The dots/squares and other shapes and grid or other patterns and designs of the skid-resistant material can be achieved through spraying or roller printing such as those commonly used printing machines employed in textile processing. Special ink jet type digital printers may also be used.

FIG. 13 shows such a textile printing technique for adhesive coating on one side. The base sheet (130) is extruded by extruder (132). Print roller (133) applies the pattern (131) to the base (130) as it passes under the roller.

Skid-resistant material coating on both sides is preferred for better performance. Also, when it is desirable to cover areas that are larger than the width of the plastic sheet, the skid-resistant material coating present on both sides will make it easier to put two sheets side-by-side with small overlapping of the two sheets. The skid-resistant material coating from both sheets coming in contact should be sufficient to keep them together (attached) without needing any additional tape to join them. The same technique may be used to apply the coating on the other side of the plastic sheeting. The process may be carried out simultaneously or sequentially.

For some plastic (polymers) sheets surface treatment might be necessary to achieve good bonding between the skid-resistant coating material and the plastic sheet. Some surface treatments such as those described in the next paragraph or others may be useful in improving the plastic sheet/skid-resistant material bonding. This is especially true when non-polar polymeric materials such as PE, PP, PET, etc., which have very low surface energy, are used for the sheet along with high surface energy skid-resistant coating materials. In such cases, the skid-resistant coating material will not spread on the plastic sheet as desired. Instead the skid-resistant material will bead up and will not bond effectively with the sheet. Even if the two are bonded initially, the bond may not last long. The skid-resistant material may come apart with friction such as rubbing action.

As mentioned in the previous paragraph, one of the problems with non-polar materials such as PE (all varieties), PP (all varieties), PET and several other polymers, is that they are difficult to bond to any other material. For such polymers, techniques such as corona discharge and atmospheric pressure plasma (also called open air plasma) can be easily applied to make their surface polar. These techniques incorporate oxygen and nitrogen containing chemical groups thus changing the surface characteristics of the polymers to more polar, improving their chemical bonding capability. The chemical bonding in such cases may be covalent or hydrogen bonding. It is also possible to modify the surface of the plastic sheet to specifically suit the chemistry of the skid-resistant material. This allows the skid-resistant material to spread on the sheet evenly, as desired, rather than bead as well as bond well. Some of these treatments can also make the sheet surface slightly rougher by etching it, providing adequate mechanical bonding with the skid-resistant coating material. A variety of gases (air, oxygen, nitrogen, argon, ammonia, etc.) or mixtures may be employed in plasma treatment, the easiest and the least expensive being air. Although some plasma require vacuum, atmospheric pressure plasma and corona treatments can be applied on line, during the extrusion of the sheet and their cost could be minimal.

### Applications of the Sheets and Variations

a. Household (domestic) painting, construction, building maintenance, remodeling, decoration, cleaning projects, etc. where lighter traffic and tools are expected. For such applications (considered light duty), sheet thicknesses could vary between 75 to 150 micrometer (3 to 6 mils).
b. For commercial buildings (professional) painting, construction, building maintenance, remodeling, decoration, cleaning projects, etc. where medium traffic and heavier tools are expected. For such applications (considered medium duty), sheet thicknesses could vary between 100 to 200 micrometers (4 to 8 mils).
c. Heavier commercial work and larger areas where wheel barrows, and other heavier traffic and equipment are expected. For such applications (considered heavy duty), sheet thicknesses could vary between 200 to 500 micrometers (8 to 20 mils).

The sheets may be color coded (for thicknesses) for easier identification. The color/dye/pigment may be added to the sheet (polymer) itself or the skid-resistant material. The sheets may be conveniently sold in 20 to 50 (or higher) meter/yards and 2 to 5 (or higher) meter/yard width.

Since the sheets will be impermeable, they will also be impervious to any liquids, e.g. water and oil based liquids.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. (not entered)

2. (not entered)

3. (not entered)

4. (not entered)

5. (not entered)

6. (not entered)

7. (not entered)

8. The method of claim 7, further comprising an initial step of extruding the base sheet of thin, flexible plastic material.

9. The method of claim 7, in which the suction cups are formed on one side of the sheet.

10. The method of claim 7, in which the suction cups are formed on both sides of the sheet.

11. The method of claim 7 in which the dies are rollers.

12. The method of claim 7 in which dies are planar molds.

13. The method of claim 7 in which the dies are heated.

14. (not entered)

15. The plastic sheet of claim 14, in which the suction cups are applied by method selected from a group consisting of adhesive bonding, thermal bonding, ultrasonic bonding and chemical bonding.

16. (not entered)

17. (not entered)

18. The plastic sheet of claim 14, in which the tapes are applied by a method selected from a group consisting of adhesive bonding, thermal bonding, ultrasonic bonding and chemical bonding.

19. (not entered)

20. (not entered)

21. The method of claim 20, in which the suction cups are applied by a method selected from a group consisting of adhesive bonding, thermal bonding, ultrasonic bonding and chemical bonding.

22. The method of claim 20, in which the suction cups are applied to both sides of the sheet.

23. The method of claim 20, in which the suction cups are applied by bonding a plurality of tapes between the suction cups and the sheet, each tape comprising a base having a length and a width, the plurality of suction cups being formed along the length of the tape.

24. The method of claim 20, in which the tapes are applied by a method selected from a group consisting of adhesive bonding, thermal bonding, ultrasonic bonding and chemical bonding.

25. The method of claim 20, in which the tapes are applied to both sides of the sheet.

26. (not entered)

27. The plastic sheet of claim 26, in which the skid-resistant material is chosen from a group consisting of an elastomer, an adhesive material, a non-adhesive tacky material, and a soft material.

28. The plastic sheet of claim 26, in which the skid-resistant material is chosen from a group consisting of amorphous olefin polymers, urethanes, copolymers, various ethylene propylene copolymers, propylene 1-butene copolymers, higher propylenes, terpolymer analogs, hot melt or water based emulsions of ethylene vinyl acetate copolymers, hot melt or water based emulsions of styrene-butadiene, cellulose acetate butyrate, ethyl cellulose containing plasticizers applied as hot melt, acrylics, natural rubber, high tack rubber based adhesives, and synthetic rubber hot melts.

29. (not entered)

30. (not entered)

31. (not entered)

32. (not entered)

33. (not entered)

34. The plastic sheet of claim 33, in which the filler is selected from a group consisting of calcium carbonate and clay.

35. (not entered)

36. (not entered)

37. The method of claim 36, in which the skid-resistant material is chosen from a group consisting of an elastomer, an adhesive material, a non-adhesive tacky material, and a soft material.

38. The method of claim 36, in which the skid-resistant material is chosen from a group consisting of amorphous olefin polymers, urethanes, copolymers, various ethylene propylene copolymers, propylene 1-butene copolymers, higher propylenes, terpolymer analogs, hot melt or water based emulsions of ethylene vinyl acetate copolymers, hot melt or water based emulsions of styrene-butadiene, cellulose acetate butyrate, ethyl cellulose containing plasticizers applied as hot melt, acrylics, natural rubber, high tack rubber based adhesives, and synthetic rubber hot melts.

39. The method of claim 36, in which the discontinuous coating is in the form of a pattern of dots or squares.

40. The method of claim 36, in which the discontinuous coating is in the form of sinusoidal or straight continuous or broken lines.

41. The method of claim 36, in which the discontinuous coating is in the form of a grid of intersecting lines running across the length and width of the sheet.

42. The method of claim 36, in which the discontinuous coating is in the form of a pattern of repeated company logos.

43. The method of claim 36, in which the discontinuous coating further comprises a filler material.

44. The method of claim 43, in which the filler is selected from a group consisting of calcium carbonate and clay.

45. The method of claim 36 in which the discontinuous coating is applied to both sides of the sheet.

46. The method of claim 36, further comprising the step, prior to the step of applying the discontinuous coating, of changing the surface characteristics of the sheet to improve chemical bonding capability.

47. The method of claim 46, in which the step of changing comprises applying a corona discharge to a surface of the sheet.

48. The method of claim 46, in which the step of changing comprises applying an atmospheric pressure plasma to a surface of the sheet.

49. The method of claim 46, in which the step of changing comprises etching a surface of the sheet.
